(19) United States
(12) Patent Application Publication
(10) Pub. No.: US 2008/0263380 A1
(43) Pub. Date: Oct. 23, 2008

(54) GPS TIME SYNCRONIZATION FOR DATA DEVICE

(76) Inventors: Joseph Ernest Dryer, Houston, TX (US); John David Lambert, Houston, TX (US); Edward McChesney Browne, Houston, TX (US)

Correspondence Address: JOSEPH E. DRYER, 10307 SUGAR HILL DRIVE, HOUSTON, TX, 77042, US

(21) Appl. No.: 11/738,825

(22) Filed: Apr. 23, 2007

(51) Int. Cl. G06F 1/12; G06F 13/42; H04L 7/00

(52) U.S. Cl. 713/400

(57) ABSTRACT

A method is presented to improve the accuracy of time synchronization of data. The invention consists of a timing module compromising a GPS interface with ability controller-based timing standard, high speed inputs and outputs and an asynchronous interface to an external processor system. It attaches a time-stamp referenced to an absolute time standard to transitions on the high speed inputs and a means for delivering these time stamps referenced to the high speed input to a computer or network. Alternatively the computer or network can specify a high speed output and an absolute time for an output transition and the timing module can deliver the specified output transition at the specified absolute time. Compared to existing systems of time synchronization, it will improve the accuracy of the timed data from the current Ethernet tolerance of up to 5 milliseconds to a possible tolerance of 250 nanoseconds.

### BACKGROUND OF THE INVENTION

1. Field of the Invention

This invention generally relates to methods of time synchronization for computer data. More particularly the invention relates to a system for synchronizing signals to and from a computer to an absolute time stamp even when the computer system is incapable of real-time operation.

2. Description of the Related Art

There are many requirements for time synchronization of electronic data. One area is in forensic reconstruction of catastrophic industrial events. Here in order to separate the source of an event from the consequences of the event the sequence of sensor inputs observed in multiple computer systems must be sorted into a sequence that might be separated by microseconds. The following discussion describes a new solution that will achieve time synchronization with dramatically reduced tolerances.

The traditional method of time-synchronizing data is to synchronize the time of the various computers involved and have the computers establish the precise time of a given signal. There are systems in existence today that use time signals from the Global Positioning System (GPS) satellites to synchronize computers for this purpose. The weakness of all such systems is that the time required for a given computer to determine a time stamp is indeterminate when the computer is not operating with a real-time operating system or when other computer tasks must be given a higher priority. This variation is not caused by a lack of synchronization of the computers themselves. It is caused by the operating systems. A large number of computer operating systems in use today are not real-time. When data are received, the computer must cease its current function and process the new input. The time required to stop a given function varies with the function. This means that the time required for any computer to perform any process may vary by an indeterminate delay that can often reach milliseconds. This is inconsequential in many applications but is a fatal problem in the case of a requirement for an accurate time fix to microseconds.

The proposed system uses a separate component to time-stamp the data prior to its input into a computer. This method can achieve time synchronization of data to within less than 250 nanoseconds, even when the sources of data and the computers are distributed worldwide and are not connected.

### BRIEF SUMMARY OF THE INVENTION

This invention, hereafter referred to as a time synchronization module, consists of a processing system with a clock which is synchronized to GPS absolute time and which has inputs and outputs synchronized to that clock and an interface to external systems to set up the triggering of outputs and reading the time stamp of inputs asynchronously. By processing system it is meant a microcontroller, microprocessor, dedicated logic unit, computer or their equivalents or combinations that allow the functions of GPS signal input analysis to retrieve a time signal for clock synchronization to that signal and allow the triggering of inputs and outputs from that clock. This system will allow an external system, such as a process control computer or an ordinary PC, to query the time synchronization module subsequent to an event for the exact GMT time stamp of an event for comparison of similar time stamps from unrelated computers, or to set up an output at an exact GMT time to initiate events to be observed by other computers.

The following discussion relates to an industrial application, but the advantages and features described are applicable to a variety of time-critical situations. It is not intended that the invention be limited to the specific application described.

In an industrial application, such as a refinery or chemical plant, there are many sensors and indicators that generate data that are recorded and reviewed. A time synchronization module could be located near a single or given group of sensors. Data would be routed through the module en route to the processors at a central control station. The data would be time-stamped at the time synchronization module, so that the time would be more accurate regardless of the current activities of the computers or networks. In the event of a catastrophic event, establishing an order of events is critical. In the event of an explosion, for example, a number of events could happen in a matter of microseconds, but establishing which event preceded the other within that time frame could result in a more accurate determination of causation.

An alternate means of installation would be to install a single time synchronization module near the input point to the computer network. This would give all the data a time stamp with a higher degree of accuracy, but would not be as accurate as described above. At the speed of light, it takes 1 nanosecond for a given datum to travel 1 foot. Placing the time stamp unit 100 feet away from the source of data would delay the time stamp by 100 nanoseconds. When dealing with tolerances as low as 200 nanoseconds, this can be significant.

### BRIEF DESCRIPTION OF THE SEVERAL VIEWS OF THE DRAWINGS

FIG. 1: This is a block diagram of the time synchronization module showing the functional elements of the invention. The GPS interface synchronizes the clock and allows precise inputs and outputs to this synchronized time standard. An external interface allows an asynchronous connection to an external processor system to allow the external system to read the absolute time stamps of the input data or to set up the absolute time for outputs.

FIG. 2: This is a block diagram for the Anteris 4 GPS interface, typical of such interface units.

FIG. 3: This figure illustrates a 4046 phase lock loop which can be used to generate a higher speed clock synchronized to a low speed input such as the GPS PPS output.

FIG. 4. This is a block diagram of the AT91SAM7 Atmel ARM processor input capture circuit. This is typical of processor high-speed time capture of input events by latching the count of an internal counter.

FIG. 5: This is a block diagram of the AT91SAM7 Atmel ARM processor timer/counter circuit in output mode. This is typical of processor high-speed outputs generated by triggering the output from a comparator comparing the count of an internal counter to a pre-established latched value.

FIG. 6: This is a block diagram of the AT91SAM7 Atmel ARM processor showing a typical processor hardware.

### DETAILED DESCRIPTION OF THE INVENTION

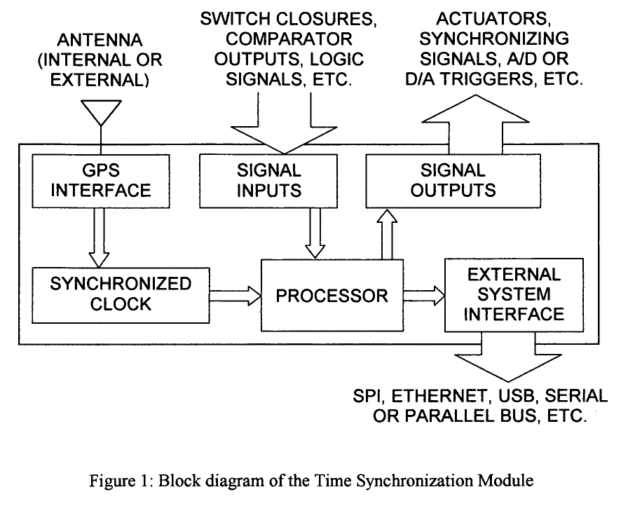

FIG. 1 presents a block diagram of the proposed invention showing the principle features: a GPS interface driving a synchronized clock, in this case within a processor, and a field input for high-speed inputs whose time is to be latched or high speed outputs which are to be changed at an absolute time. An interface to another processor which need not have the ability to rapidly react to inputs or precisely create outputs allows the inputting or outputting of events with a much relaxed time requirement.

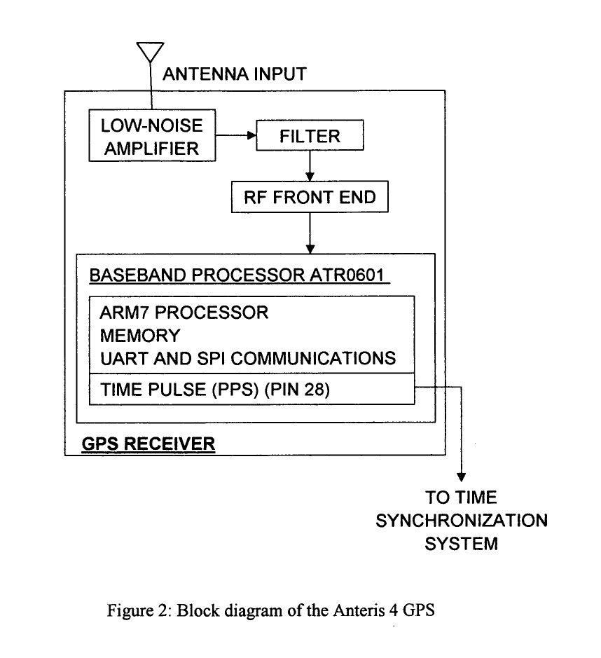

In the proposed invention it is first necessary to have a connection to the array of GPS satellites. This is well known in the art and poses no problems in obtaining the transmitted satellite time and the accurately determines received time of the signal from each satellite. Most GPS systems do this as a matter of course and it is common to put out a one pulse per second (PPS) signal with edges accurate to the GMT second transitions. This PPS signal can be used to synchronize computers in a manner that utilizes the good short term stability and poor long term stability of the local oscillator with the poor short term stability but good long term stability of the GPS measurement to provide a local time that is referenced to an international standard and stable. NIST has used such techniques to synchronize stations around the globe to accuracies of tens on nanoseconds (http://tf.nist.gov/time/oneway.htm). The easiest implementation of this concept is to incorporate within the time synchronization module a GPS chip such as the Antaris 4 by u-blox AG (www.u-blox.com). A block diagram of this sub-module is shown in FIG. 2. Noteworthy is the timepulse output on pin 28 which presents a one pulse per second 100 millisecond pulse synchronized on the rising edge. As will be discussed later, the ATR0601 shown in FIG. 2 is an ARM-based processor.

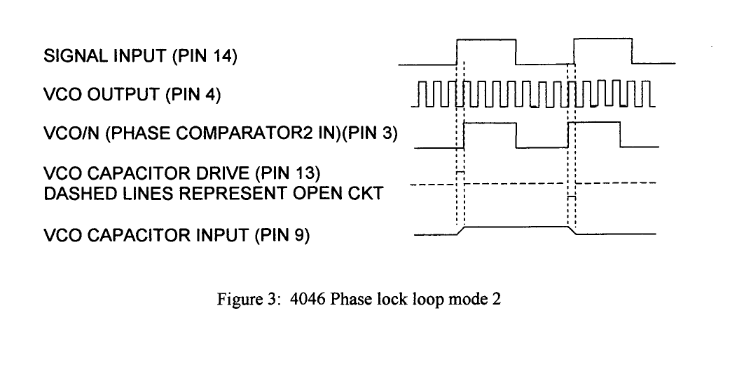

The PPS output from the GPS processor is based on an internal high-stability clock which is synchronized to the GPS time signals and is capable of 50 ns accuracy limited by the granularity of the processor clock. If this signal is used as the low-frequency input to a high-speed phase-lock loop the granularity of the system clock can be averaged out to give a much more accurate clock edge. FIG. 3 shows a 4046 phase lock loop operating in phase comparator 2 mode where the difference between the divided-down VCO frequency and the low frequency reference voltage feeds a low-lass filter to adjust the VCO frequency to the point where the edges over the period of the low-pass filter would on average match. Because the VCO is capable of operating with continuous frequency adjustments there is not a granularity issue with the VCO output and the granularity of the discrete clock in the GPS processor would be averaged out. The VCO output could then be used as the clock for a timing processor synchronized to the grosser PPS signal from the GPS processor to allow finer time resolution.

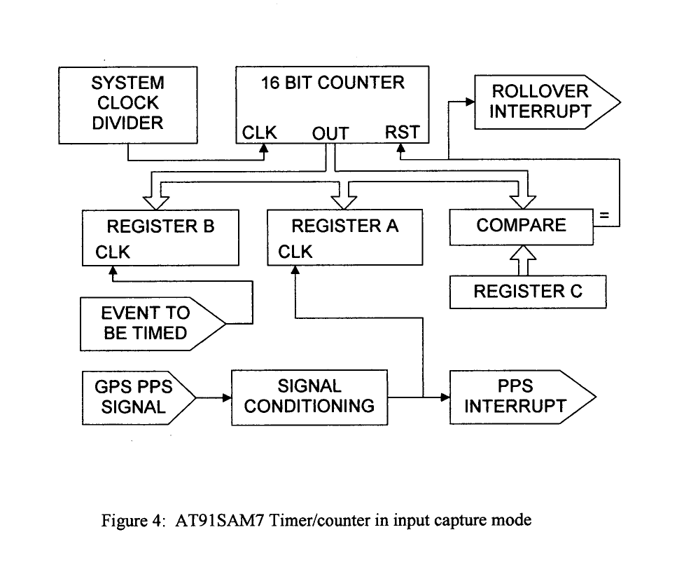

The timing processor could be a second ARM processor running at a high clock speed. The timing processor could have asynchronous, non-interrupt-driven capture buffers as shown in FIG. 4 for the Atmel AT91SAM7S ARM processor. Here a 16 bit clock can be configured to run synchronously with the phase-locked clock synchronized to the GPS sub-module. An input transition on the TIOA or TIOB input lines can capture the clock count in Capture registers A or B. This requires no interruption of the processor operation and would generate an interrupt to allow the processor to query the capture buffers at leisure to record the time of capture of the input signal.

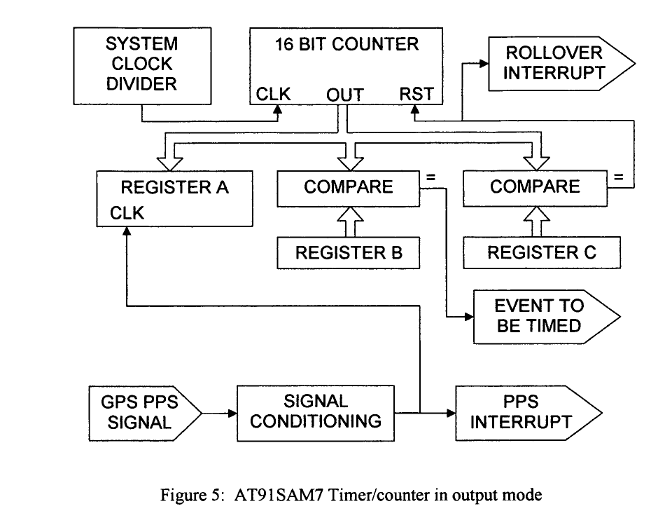

FIG. 5 shows a similar operation for the Atmel AT91SAM7S ARM processor of an output synchronized signal. Register A, for example, can be set up with a value so that when the synchronized 16 bit counter is equal to that value, Compare Register A will trigger and the output controller will toggle an output pin.

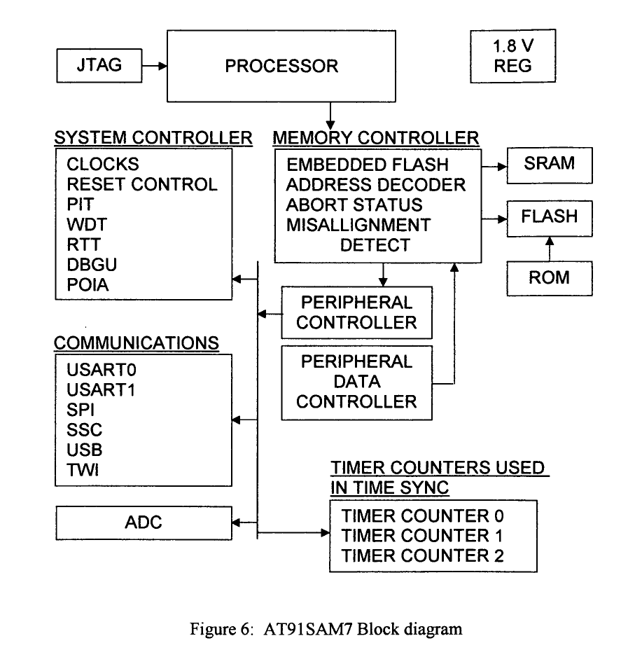

The Atmel AT91SAM7S ARM processor described has numerous interfaces to other processors such as USB, 232 serial, 485 serial and SPI as shown in the block diagram in FIG. 6. Other similar processors have Ethernet and CAN interfaces. This would allow the time synchronization module containing this or similar processors to connect to preload outputs and look at input events without a tight time constraint while insuring that the synchronized inputs and outputs are valid in real time. Some other systems which would benefit from this ability would be processors or systems operating with a unsynchronized clock or an operating system that would not allow tight timing due to being non-real time or real time with higher level priorities to

It is known by those skilled in the art that the synchronization to the GPS signal described as being accomplished by a phase locked loop could also be done with a similar algorithm within the processor, and that the input and output latching could also be done with discrete counters, latches and comparators. It should also be noted that since the operation of the input and output synchronization are done asynchronously with the processor operation that they could also be done in the same processor that processes the GPS signal, such as the ATR0601 shown in FIG. 2.

It is known to those skilled in the art that, while the synchronized output signal shown is a digital switch, the output signal could also be the output from a digital-to-analog (DAC) converter where the analog output transitions are synchronized to timing points established within the time synchronization module from asynchronously loaded timing points from an external module.

It can be recognized by those familiar with the art that the term processor, while it has referred to a microcontroller in the previous discussion is meant to encompass the functional electronic equivalents that can be achieved by discrete logic, PGAs, PLAs, general purpose processors and many means of achieving the same functionality electronically.

1. A method for synchronizing event signal inputs and outputs to an absolute time comprising:
a. A means for generating a processor clock from a GPS interface synchronized to the GPS absolute time standard.
b. A means for operating a counter system synchronized to the GPS absolute time standard from said processor clock.
c. A means for latching the state of said counter system in response to input signals.
d. A means for delivering said latched counter state in response to requests from an outside system without tight time constraints.

2. The method of claim 1 wherein said means of delivering said counter state comprises a storage in registers of a processing system and delivering said registers over a serial connection to an outside system.

3. A method for synchronizing event signal inputs and outputs to an absolute time comprising:
a. A means for generating a processor clock from a GPS interface synchronized to the GPS absolute time standard.
b. A means for operating a counter system synchronized to the GPS absolute time standard from said processor clock.
c. A means for delivering from an outside system without tight time constraints required timing for output signal generation.
d. A means for outputting a signal when said counter system reaches said required timing.

4. The method of claim 3 wherein said means of delivering said required timing comprises receiving said timing values over a serial connection to an outside system and a storage in registers of a processing system.

5. The method of claim 3 where said outputting of a signal is a logic level change on an output.

6. The method of claim 3 where said outputting of a signal is an analog signal change on an output or one of a sequence of analog signal changes.
